(19) United States
(12) Patent Application Publication
(10) Pub. No.: US 2006/0198945 A1
(43) Pub. Date: Sep. 7, 2006

(54) Dilution method for liquid material used for forming an alignment film, manufacturing method for liquid-crystal device, and electronic equipment

(75) Inventor: Kei Hiruma, Chino-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/362,036

(22) Filed: Feb. 27, 2006

(30) Foreign Application Priority Data
Mar. 2, 2005 (JP) JP2005-057091

(51) Int. Cl. B05D 5/06; B05D 5/12

(52) U.S. Cl. 427/58; 427/162

(57) ABSTRACT

A dilution method for liquid material used for forming an alignment film, includes: diluting the liquid material by adding a diluent having a prescribed solubility parameter to the liquid material, the diluent is a solvent having a solubility parameter which is substantially identical to a solubility parameter of the liquid material.

### CROSS-REFERENCE TO RELATED APPLICATION

This application claims priority to Japanese Patent Application No. 2005-057091, filed Mar. 2, 2005, the contents of which are incorporated herein by reference.

### BACKGROUND

1. Technical Field

The present invention relates to a dilution method for liquid. material used for forming an alignment film, a manufacturing method for liquid-crystal device, and electronic equipment.

2. Related Art

Electro-optical devices using displays, display light sources and the like are known. The manufacturing process of electro-optical devices, includes a process that disposes material on a body (for example, a substrate) constituting a base. The material disposition technology is closely related to quality and functions, and is therefore important for achieving improvements in the respective aforementioned devices.

As the technology for disposing material on the body, there is the method of ejecting liquid material in droplets via a nozzle provided in the ejection head (droplet ejection method or ink-jet method). Compared to other common application technologies such as the spin-coat method, this droplet ejection method has the advantages that there is little waste of the consumed liquid material, and that control of the quantity and positioning of the liquid material disposed on the body is facilitated.

With regard to the manufacturing process of a liquid-crystal device which is one example of an electro-optical device, Japanese Unexamined Patent Application, First Publication No. 2001-42330, discloses a technology that disposes liquid material including the formative material of an alignment film on a substrate using the droplet ejection method. With this technology, the liquid material is used to which an alcoholic solvent such as butyl cellosolve is added.

Liquid material to which an alcoholic solvent such as butyl cellosolve has been added tends to produce turbidity and precipitation of solid content. Such turbidity and precipitation of solid content causes the occurrence of clogging in the nozzle of the ejection head.

### SUMMARY

An advantage of some aspects of the invention is to provide a dilution method for liquid material used for forming an alignment film, that is suited to the droplet ejection method, and to provide a manufacturing method for liquid-crystal device, and electronic equipment.

A first aspect of the invention provides a dilution method for liquid material used for forming an alignment film, including: diluting the liquid material by adding a diluent having a prescribed solubility parameter to the liquid material; wherein the diluent is a solvent having a solubility parameter which is substantially identical to a solubility parameter of the liquid material.

In the dilution method of the first aspect of the invention, it is possible to prevent turbidity and precipitation of solid content, by using a solvent having a solubility parameter which is substantially identical to a solubility parameter of the liquid material as the diluent. As a result, ejection defects due to clogging of the ejection head in the droplet ejection method are prevented. Moreover, control of the solid-content concentration of the liquid material is facilitated by prevention of the precipitation of solid content.

It is preferable that, in the dilution method of the first aspect of the invention, when the solubility parameter of the liquid material be σi, and the solubility parameter of the diluent be σs, the ratio σs/σi be greater than or equal to 0.8 and less than 1.2.

It is preferable that, in the dilution method of the first aspect of the invention, the ratio σs/σi be greater than or equal to 0.9 and less than 1.1.

It is preferable that, in the dilution method of the first aspect of the invention, liquid material include a plurality of solvents, and the diluent be the solvent having a solubility parameter which is closest to a solubility parameter of the liquid material among the plurality of solvents included in the liquid material.

It is preferable that, in the dilution method of the first aspect of the invention, the diluent be a solvent which has a solubility parameter which is substantially identical to a solubility parameter of the liquid material, and which is not included in the liquid material.

A second aspect of the invention provides a manufacturing method for liquid-crystal device, including: disposing a liquid material on a substrate by a droplet ejection method, the liquid material is used for forming an alignment film, and the liquid material is diluted by the above described dilution method.

In the manufacturing method of the second aspect of the invention, it is possible to manufacture a liquid-crystal device of high quality.

A third aspect of the invention provides an electronic equipment including the liquid-crystal device manufactured by the above described manufacturing method.

According to this electronic equipment, it is possible to achieve quality improvements.

### BRIEF DESCRIPTION OF THE DRAWINGS

The invention will be described with reference to the accompanying drawings, wherein like numbers reference like elements.

FIG. 1 is a perspective view of a schematic configuration of a droplet ejection device.

FIG. 2 is a view for explaining liquid ejection principles of the piezo method.

FIG. 3 is a view of an equivalent circuit of a liquid-crystal device.

FIG. 4 is a plan view of pixel structures of the liquid-crystal device of FIG. 3.

FIG. 5 is a sectional view of the liquid-crystal device of FIG. 3.

FIG. 6 is a view for explaining the manufacturing one example of the method for liquid-crystal device of FIG. 3.

FIGS. 7A to 7C are perspective views of examples of the electronic equipment.

### DESCRIPTION OF EXEMPLARY EMBODIMENTS

Dilution method for liquid material used for forming an alignment film

In the dilution method for liquid material of this invention, a solvent having a solubility parameter which is the same order as a solubility parameter of the liquid material is used as the diluent. Here, the liquid material is used for forming an alignment film, in the manufacturing method for liquid-crystal device.

When e=cohesive energy density of molecule, E=molar heat of evaporation, V=molecular capacity (volume occupied by 1 mol), X=molar fraction, the solubility parameter σ may be expressed by the following formula (1). The mixed-solvent solubility parameter amix may be expressed by the following formula (3).

$$\begin{matrix}δ = \sqrt{e} & ( 1 ) \\ e = \frac{E}{V} & ( 2 ) \\ δ mix = \frac{\sum Xn Vn δ n}{\sum Xn Vn} & ( 3 )\end{matrix}$$

By using a solvent having a solubility parameter close to a solubility parameter of the liquid material as the diluent, it is possible to prevent turbidity and precipitation of solid content. The diluent may be a solvent included in the liquid material, or it may be a solvent not included in the liquid material.

When the solubility parameter of the liquid material is σi and the solubility parameter of the solvent is σs, it is preferable that the ratio σs/σi be greater than or equal to 0.8 but less than 1.2, and more preferable that it be greater than or equal to 0.9 but less than 1.1. When σs/σi is less than 0.8 or greater than or equal to 1.2, turbidity and precipitation of solid content tend to occur when the solvent is added to the liquid material, which is undesirable. Moreover, when σs/σi is greater than or equal to 0.9 and less than 1. 1, turbidity and the precipitation of solid content are more reliably prevented when solvent is added to the liquid material.

As representative examples of the liquid material, there is the material including polyimide (PI) as the primary solid content, and γ-butylolactone and butyl cellosolve as the solvents. The solubility parameters are: liquid material=0.39, γ-butylolactone=0.4, and butyl cellosolve=0.3.

γ-butylolactone possesses the function of dissolving the solid content (polyimide). Butyl cellosolve possesses the function of controlling the surface tension of the liquid material.

Table 1 below shows the results where γ-butylolactone was added to this liquid material, while Table 2 below shows the results where butyl cellosolve was added (processing temperature was 23° C.; rate of addition was expressed in weight %).

Viscosity of the original liquid material was 46 mPa·s, solid content concentration (weight %) of the original liquid material was 4 wt %, component concentration (weight %) of the γ-butylolactone in the original liquid material was 80 wt %, component concentration (weight %) of the butyl cellosolve in the original liquid material was 10 wt %, with the remaining 10 wt % of solvent being composed of different components.

TABLE 1
γ-butylolactone

| Rate of | |
|---|---|
| addition (%) | Change at time of adding solvents to the liquid material |
| 2 | No precipitation, also no occurrence of white turbidity |
| 3 | No precipitation, also no occurrence of white turbidity |
| 4 | No precipitation, also no occurrence of white turbidity |
| 5 | No precipitation, also no occurrence of white turbidity |
| 10 | No precipitation, also no occurrence of white turbidity |

TABLE 2
Butyl cellosolve

| Rate of | |
|---|---|
| addition (%) | Change at time of adding solvents to the liquid material |
| 2 | — |
| 3 | No precipitation, also no occurrence of white turbidity |
| 4 | No precipitation, supernatant had white turbidity |
| 5 | PI precipitated; dissolved upon agitation |
| 10 | PI precipitated; dissolved upon agitation |

It is clear as shown in Table 1 and Table 2, when γ-butylolactone (σ=0.4) was added to the aforementioned liquid material (σ=0.39), turbidity and precipitation of solid content did not occur. In contrast, when butyl cellosolve (σ=0.3) was added, turbidity and precipitation of solid content (polyimide: PI) occured as the rate of addition increases.

In the case where N-N dimethylacetoamide (σ=0.37) was added to the aforementioned liquid material (σ=0.39), it was confirmed that turbidity and precipitation of solid content do not occur.

Droplet Ejection Device

Next the droplet ejection device (ink-jet device) used in the droplet ejection method is described. In the various drawings used in the following description, the scales of the respective members have been suitably altered to give each member a perceivable size.

By using the aforementioned dilution method, it is possible to prevent ejection defects due to clogging when the liquid material is ejected using the droplet ejection method. By preventing the precipitation of solid content, control of the solid content concentration of the liquid material is facilitated.

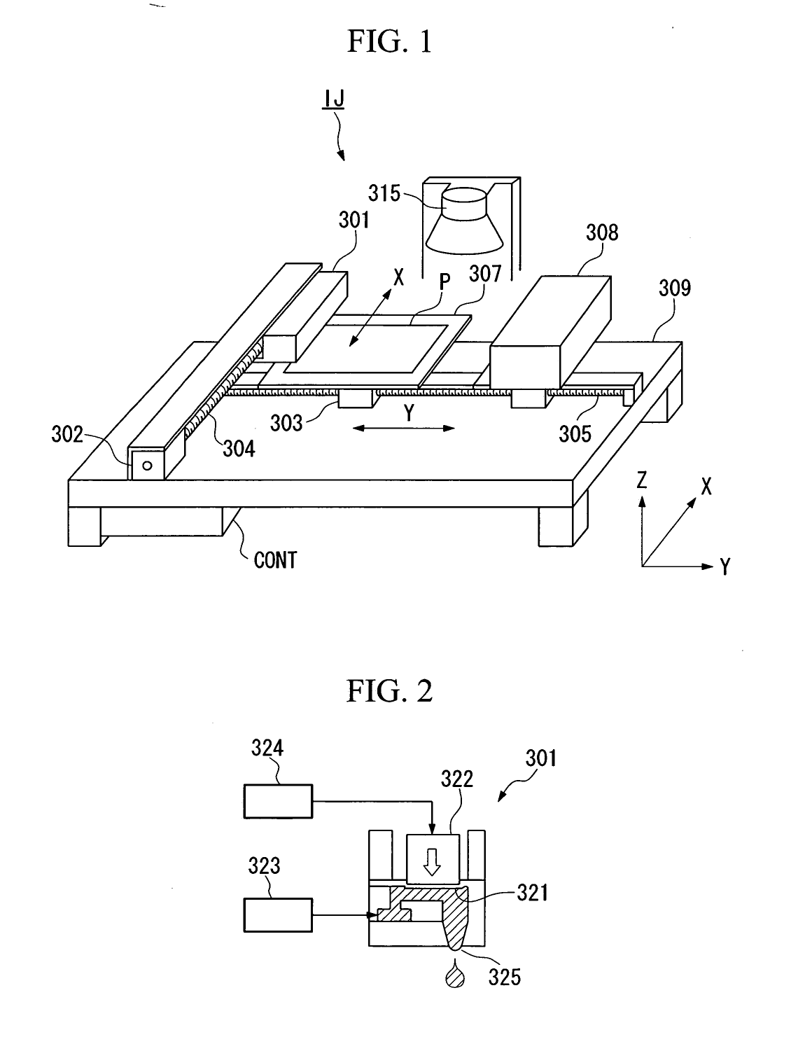

FIG. 1 is a perspective view of a schematic configuration of the droplet ejection device.

This droplet ejection device IJ ejects the liquid material in droplet form from the nozzle of the droplet ejection head, and is configured to include a droplet ejection head 301, X-axis drive shaft 304, Y-axis guide shaft 305, controller CONT, stage 307, cleaning mechanism 308, base 309, heater 315, and so on.

The stage 307 supports the substrate P on which the liquid material is disposed by this droplet ejection device IJ, and the substrate P is provided with fixing mechanism (not illustrated in the drawing) which fixes the substrate P to a standard position.

The droplet ejection head 301 is a droplet ejection head of the multi-nozzle type provided with a plurality of ejection nozzles, and the lengthwise direction and Y-axis direction are congruent. The plurality of ejection nozzles are provided at fixed intervals in parallel with the lengthwise direction and Y-axis direction on the underside of the droplet ejection head 301. The liquid material is ejected from the ejection nozzle of the droplet ejection head 301 onto the substrate P supported by the stage 307.

The X-axis drive motor 302 is connected to the X-axis drive shaft 304. The X-axis drive motor 302 is a stepping motor or the like, and rotates the X-axis drive shaft 304 when drive signals for the X-axis direction are supplied from the controller CONT. When the X-axis drive shaft 304 is rotated, the droplet ejection head 301 is moved in the X-axis direction.

The Y-axis guide shaft 305 is fixed so as not to move relative to the base 309. The stage 307 is provided with the Y-axis drive motor 303. The Y-axis drive motor 303 is a stepping motor or the like, and moves the stage 307 in the Y-axis direction when drive signals for the Y-axis direction are supplied from the controller CONT.

The controller CONT supplies voltage for droplet ejection control to the droplet ejection head 301. It also supplies the drive pulse signals that control movement of the droplet ejection head 301 in the X-axis direction to the X-axis drive motor 302, and supplies the drive pulse signals that control movement of the stage 307 in the Y-axis direction to the Y-axis drive motor 303.

The cleaning mechanism 308 cleans the droplet ejection head 301. The cleaning mechanism 308 is provided with a Y-axis drive motor (not illustrated in the drawings). The cleaning mechanism 308 is moved along the Y-axis guide shaft 305 by the driving of this Y-axis drive motor. The controller CONT also controls the movement of the cleaning mechanism 308.

The heater 315 is to conduct thermal treatment of the substrate P by lamp annealing, and conducts evaporation and drying of the solvents included in the liquid material applied onto the substrate P. The controller CONT also controls the turning on and off of the power source of this heater 315.

In the droplet ejection device IJ, the droplet ejection head 301 and the stage 307 supporting the substrate P conduct relative scanning movement, while the liquid material is ejected in droplet form onto the substrate P from the droplet ejection head 301. The ejection nozzles of the droplet ejection head 301 are provided in parallel at fixed intervals in the Y-axis direction which is the non-scanning direction (X-axis direction: scanning direction, Y-axis direction: non-scanning direction). In FIG. 1, the droplet ejection head 301 is arranged to be perpendicular to the direction of advancement of the substrate P, but also the angle of the droplet ejection head 301 may be adjusted, so that it intersects the direction of advancement of the substrate P.

If this is done, it is possible to regulate the pitch among nozzles by adjusting the angle of the droplet ejection head 301. It is also acceptable to enable adjustment of the distance between the substrate P and nozzle surface.

FIG. 2 is a view of a schematic block diagram of the droplet ejection head for explaining the principles of liquid-material ejection by the piezo method.

In FIG. 2, a piezo element 322 is installed adjacent to a liquid-material chamber 321 which stores the liquid material. The liquid material is supplied to the liquid-material chamber 321 via a liquid-material supply system 323 including a material tank that stores the liquid material. A piezo element 322 is connected to a drive circuit 324, and voltage is impressed upon the piezo element 322 via this drive circuit 324, thereby deforming the piezo element 322, and elastically deforming the liquid-material chamber 321. As a result of the change in internal capacity at the time of this elastic deformation, the liquid material is ejected from the nozzle 325. In this case, it is possible to control the distortion amount of the piezo element 322 by altering the value of the impressed voltage.

By varying the frequency of the impressed voltage, it is possible to control the distortion speed of the piezo element 322. As droplet ejection by the piezo method does not involve application of heat to the material, it has the advantage that composition of the material is not easily affected.

Liquid-Crystal Device

Next, a description is given of the liquid-crystal panel (device) manufactured using the aforementioned droplet ejection device and the liquid-crystal device (electro-optical device) provided with the pertinent liquid-crystal panel.

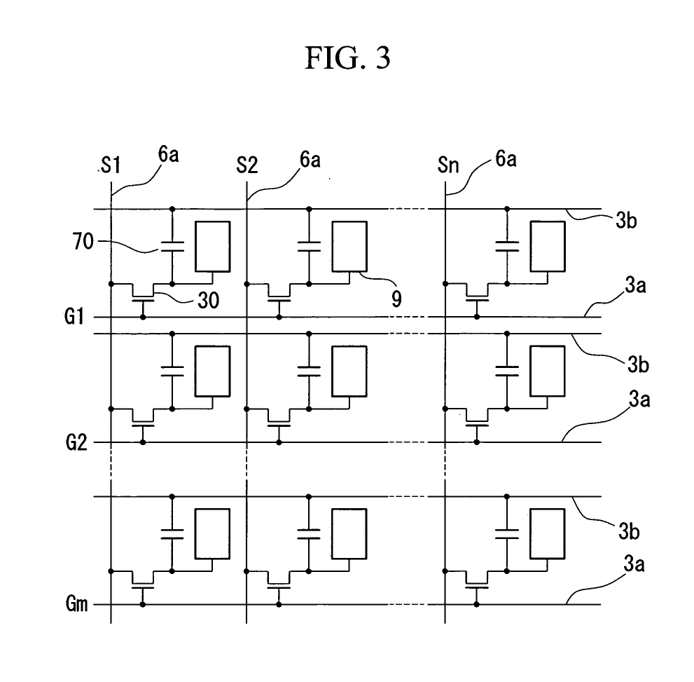

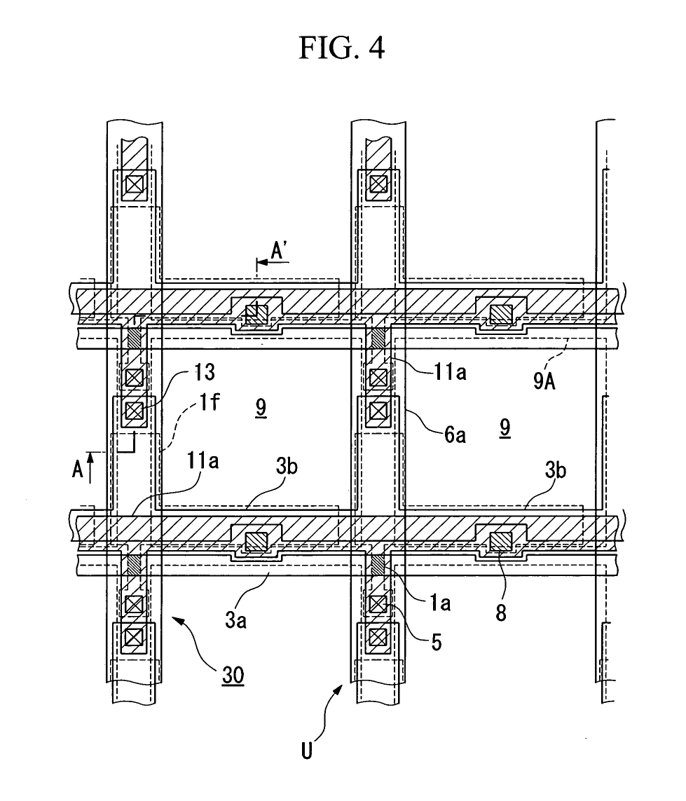

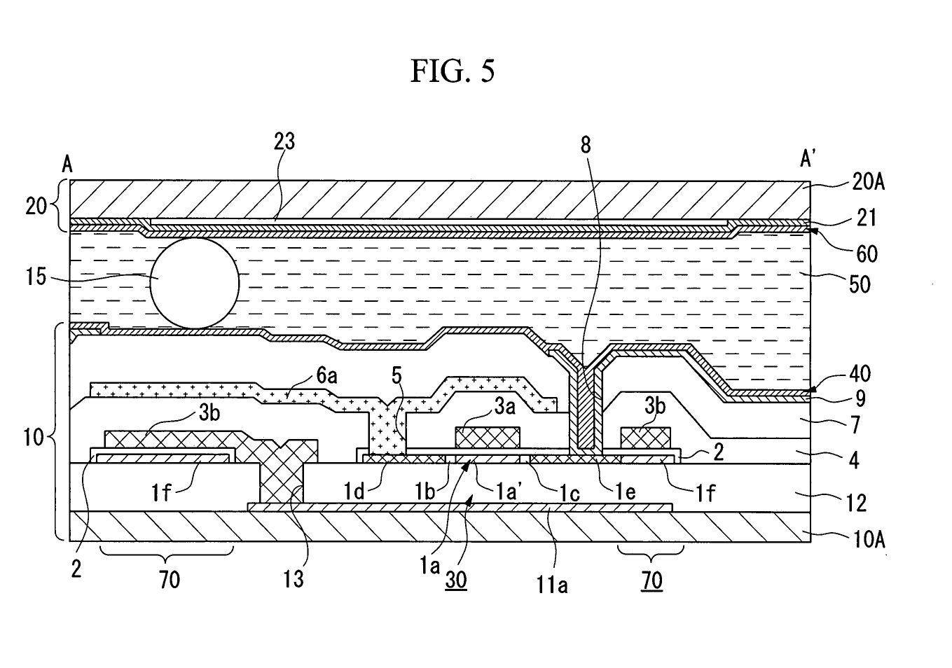

The liquid-crystal device shown in FIG. 3, FIG. 4 and FIG. 5 is a transmission-type liquid-crystal display of the active matrix type using a TFT (thin film transistor) element as the switching element. FIG. 3 is an equivalent circuit diagram of the switching element, signal lines and the like in a plurality of pixels arranged in matrix form of the transmission-type liquid-crystal device. FIG. 4 is a plan view of the structure of a plurality of mutually adjacent pixel groups of the TFT array substrate on which data lines, scanning lines, pixel electrodes and the like are formed. FIG. 5 is a cross-sectional view of the liquid-crystal device taken along the line A-A′ shown in FIG. 4. In FIG. 5, the upper part of the drawing shows a side to which the light incidence, while the lower part of the drawing shows a side to which an observer views. In the respective drawings, the scales of the respective layers and respective members have been differentiated in order to give the respective layers and respective members perceivable sizes in the drawings.

In the liquid-crystal device of this embodiment, as shown in FIG. 3, a pixel electrode 9 and a TFT element 30 are respectively formed in each of the plurality of pixels arranged in matrix form. The TFT element 30 is a switching element which serves to control energizing of the pertinent pixel electrode 9.

The data line 6a to which image signals are supplied is electrically connected to the source of the pertinent TFT element 30. The image signals S1, S2, . . . , Sn that are written into the data lines 6a are either supplied in this order in line sequence, or are supplied by group to the plurality of mutually adjacent data lines 6a.

The scanning line 3a is electrically connected to the gate of the TFT element 30, and the scanning signals G1, G2, . . . Gn are applied in line sequence in pulse manner at the prescribed timing to the plurality of scanning lines 3a. In addition, the pixel electrode 9 is electrically connected to the drain of the TFT element 30, and writes at the prescribed timing the image signals S1, S2, . . . Sn supplied from the data lines 6a by activation of the TFT element 30 which is the switching element for the fixed period only.

Image signals S1, S2, . . . , Sn of the prescribed level which are written into the liquid-crystal via the pixel electrode 9 are retained for a fixed period between the pixel electrode 9 and a below-mentioned shared electrode. Alteration of the alignments and order of the molecular aggregates according to the impressed voltage level enables the liquid-crystal to modulate light and conduct graduated display. In order to prevent leakage of retained image signals, cumulative capacity 70 is applied in parallel with the liquid-crystal capacity formed between the pixel electrode 9 and the shared electrode.

Next, based on FIG. 4, a description is given of the planar structure of essential parts of the liquid-crystal device of this embodiment.

As shown in FIG. 4, a plurality of rectangular pixel electrodes 9 (contours are shown by the broken line part 9A) composed of transparent conductive material such as indium tin oxide (hereinafter abbreviated as “ITO”) are provided in matrix form on the TFT array substrate. The data lines 6a, scanning lines 3a and capacity lines 3b are respectively provided along the vertical and horizontal boundaries of the pixel electrodes 9. In this embodiment, a region formed by the data line 6a, scanning line 3a, capacity line 3b and so on arranged so as to surround the respective pixel electrode 9 is a pixel. A plurality of the pixels are formed on the TFT array substrate. The liquid-crystal device displays an each of the individual pixels. The regions formed in a grid-like lattice shape which are formed by the data lines 6a, scanning lines 3a, capacity lines 3b and so on surrounding the respective pixel electrodes 9 are non-display regions U where image display is not conducted.

The data lines 6a are electrically connected via contact holes 5 to the below-mentioned source regions in a semiconductor layer 1a composed, for example, of polysilicon film that constitutes the TFT element 30.The pixel electrodes 9 are electrically connected via contact holes 8 to the below-mentioned drain regions in the semiconductor layer 1a. In the semiconductor layer 1a, the scanning lines 3a are faced the below-mentioned channel regions (the regions with the slanted lines at the upper left of the drawing); the scanning lines 3a finction as gate electrodes in the portions that are faced the channel regions.

The respective capacity lines 3b possess a main line part extending in an substantially linear manner along scanning line 3a (that is, a first region formed along scanning line 3a viewed in a planar manner) and a projecting part that projects upward in the drawing along data line 6a from the point of intersection with data line 6a (that is, a second region extending along data line 6a viewed in a planar manner). In FIG. 4, a plurality of first antiglare films 11a is provided in the regions shown by the slanted lines at the upper right.

Next, the sectional structure of the liquid-crystal device of this embodiment is described based on FIG. 5.

As stated above, FIG. 5 is a cross-sectional view of the liquid-crystal device taken along the line A-A′ of FIG. 4. This cross-sectional view shows the configuration of the regions formed by the TFT element 30.In the liquid-crystal device of this embodiment, the liquid-crystal layer is interposed between a TFT array substrate 10 and a facing substrate 20 which is faced to the substrate 10.

A liquid-crystal layer 50 is composed, for example, from one type of liquid-crystal or from the mixture of several types of nematic liquid-crystal. The liquid-crystal layer 50 is aligned by alignment films 40 and 60 between a pair of alignment films 40 and 60. The TFT array substrate 10 includes a substrate body 10A composed of translucent material such as quartz. In the substrate body 10A, the TFT element 30, pixel electrodes 9 and alignment film 40 are formed on which the liquid-crystal layer 50 is arranged. The facing substrate 20 includes a substrate body 20A composed of translucent material such as glass or quartz. In the facing substrate 20, the shared electrode 21 and alignment film 60 are formed on which the liquid-crystal layer 50 is arranged. The prescribed substrate distance between the TFT array substrate 10 and the facing substrate 20 is maintained via a spacer 15.

In the TFT array substrate 10, pixel electrodes 9 are provided on the surface of the substrate body 10A on which the liquid-crystal layer 50 is arranged. The pixel element 30 for pixel switching that conducts switching control of each pixel electrode 9 is provided at positions adjacent to each pixel electrode 9. The TFT element 30 for pixel switching possesses a LDD (lightly doped drain) structure, and is provided with scanning lines 3a, a channel region 1a′ of the semiconductor layer 1a that forms a channel due to the electric field emanating from the pertinent scanning lines 3a, a gate insulation film 2 that insulates the scanning lines 3a and semiconductor layer 1a, data lines 6a, a low-concentration source region 1b and low-concentration drain region 1c of the semiconductor layer 1a, and a high-concentration source region 1d and high-concentration drain region 1e of the semiconductor layer 1a.

A second interlayer insulating film 4 is formed on the substrate body 10A including on the aforementioned scanning lines 3a and on the gate insulation film 2. This second interlayer insulating film 4 is provided with apertures for a contact hole 5 that communicates with the high-concentration source region 1d and a contact hole 8 that communicates with the high concentration drain region 1e. In short, the data lines 6aare electrically connected to the high-concentration source region 1d via the contact hole 5 that passes through the second interlayer insulating film 4.

Furthermore, on the data lines 6a and the second interlayer insulating film 4, a third interlayer insulating film 7 is formed that is provided with an aperture for the contact hole 8 that communicates with the high concentration drain region 1e. That is, the high concentration drain region 1e is electrically connected to the pixel electrodes 9 via the contact hole 8 that passes through the second interlayer insulating film 4 and third interlayer insulating film 7.

The substrate body 10A on which the liquid-crystal layer 50 is arranged, a first antiglare film 11a is formed in the region which the TFT element 30 is formed.

The first antiglare film 11a is provided in order to prevent the return light which passes through the TFT array substrate 10, is reflected by the illustrated underside of the TFT array substrate 10 (the boundary face between the TFT array substrate 10 and air), and returns toward the liquid-crystal layer 50 from reaching at least the channel region 1a′ of the semiconductor layer 1a as well as the low concentration source 1b and low concentration drain region 1c.

A first interlayer insulating film 12, which serves to electrically insulate the semiconductor layer 1a including the pixel-switching TFT element 30 from the first antiglare film 11a, is formed between the first antiglare film 11a and the pixel-switching TFT element 30. Furthermore, as shown in FIG. 4, in addition to providing the first antiglare film 11a on the TFT array substrate 10, the first antiglare film 11a is configured to be electrically connected to the capacity line 3b via contact hole 13.

Furthermore, the alignment film 40 which controls alignment of the liquid-crystal molecules in the liquid-crystal layer 50 when voltage is not impressed is formed on the outermost surface of the TFT array substrate 10 on which the liquid-crystal layer 50 is arranged, that is, on the pixel electrodes 9 and the third interlayer insulating film 7. Accordingly, in the region provided with this type of TFT element 30, a configuration is produced where a plurality of irregularities or level difference portions are formed on the outermost surface of the TFT array substrate 10 on which the liquid-crystal layer 50 is arranged, that is, on the interposed surface of which the liquid-crystal layer 50 is arranged.

On the other hand, the substrate body 20A on which the liquid-crystal layer 50 is arranged, a second antiglare film 23 is formed in the region facing the formation region of the scanning lines 3a, data lines 6a and TFT element 30, that is, in the region other than the open regions of each pixel part.

The second antiglare film 23 serves to prevent the entry of incoming light into the channel region 1a′, low concentration source region 1b and low concentration drain region 1c of the semiconductor layer 1a of the TFT element 30.

Furthermore, a shared electrode 21 composed of ITO or the like is formed on which the liquid-crystal layer 50 is arranged on the substrate body 20A. On the shared electrode 21, the alignment film 60 is formed on which the liquid-crystal layer 50 is arranged. The alignment film 60 controls alignment of the liquid-crystal molecules in the liquid-crystal layer 50 when voltage is not impressed.

Manufacturing Method of Liquid-Crystal Device

Next, the manufacturing method of the aforementioned liquid-crystal device is described with reference to drawings of an example thereof.

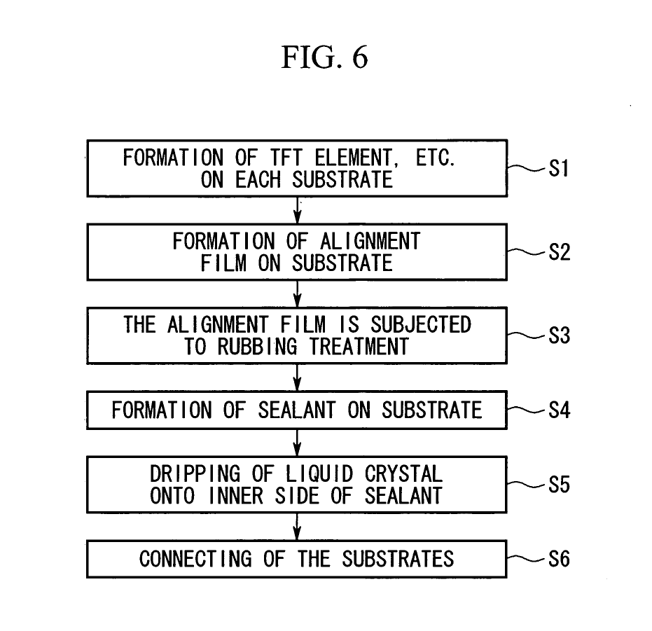

FIG. 6 is a view for explaining the manufacturing method for liquid-crystal device of this embodiment, and shows its process flow. That is, this manufacturing method forms alignment films on a pair of substrates, conducts rubbing treatment of these alignment films, and forms a frame-like sealant on one of the substrates, after which it drips liquid-crystal inside this sealant frame, and affixes this substrate to the other substrate. Below, the details pertaining to each step in the flow are described.

First, as shown in FIG. 5 and FIG. 6, in order to configure the TFT element 30 and the like on the underside of the substrate body 10A composed of glass or the like, one forms the antiglare film 11a, first interlayer insulating film 12, semiconductor layer 1a, channel region 1a′ , low concentration source region 1b, low concentration drain region 1c, high concentration source region 1d, high concentration drain region 1e, cumulative capacity electrode 1f, scanning line 3a, capacity line 3b, second interlayer insulating film 4, data lines 6a, third interlayer insulating film 7, contact hole 8, and pixel electrodes 9 (Step S1).

Next, the liquid material used for forming an alignment film is applied to the substrate body 10A using the aforementioned droplet ejection device, and the alignment film 40 is formed 9 (Step S2).

Subsequently, the alignment film 40 is subjected to rubbing treatment in the prescribed direction, and the TFT array substrate 10 is produced (Step S3). In addition, the antiglare film 23, shared electrode 21 and alignment film 60 are formed on the substrate body 20A, the aforementioned alignment film 60 is subjected to rubbing treatment in the specified direction, and the facing substrate 20 is produced.

Next, frame-like sealant is formed on the aforementioned TFT array substrate 10 or facing substrate 20 (Step S4). An ultraviolet curable resin or the like may be used as the sealant. This is formed in frame form by the print method or the like, and is formed into an open frame shape that has no liquid-crystal injection ports.

At this point, in order to assure the prescribed interval between the substrates, the spacer 15 into the sealant so as to assure the prescribed substrate interval, may be dispersed.

Next, a prescribed amount of liquid-crystal corresponding to a thickness of the pertinent liquid-crystal device is dripped onto the TFT array substrate 10 that forms the sealant (Step S6). Subsequently, the TFT array substrate 10 onto which the liquid-crystal has been dripped and the facing substrate 20 are connected so as to include the liquid-crystal between the TFT array substrate 10 and the facing substrate 20. Furthermore, the optical films of the phase plate, deflection plate and the like (not illustrated) on the outermost side of the TFT array substrate 10 and facing substrate 20 are connected, and a liquid-crystal device which is a display device provided with the cell structure shown in FIG. 5 is manufactured.

In the aforementioned liquid-crystal device, liquid material is disposed on the substrate bodies 10A and 20A using the droplet ejection method (ink-jet method). That is, the alignment films 40 and 60 are formed on the substrate bodies 10A and 20A by the ejecting and drying of liquid material used for forming an alignment film, using the aforementioned droplet ejection method IJ (see FIG. 1).

In this embodiment, by using the aforementioned dilution method, the liquid material is diluted, and the viscosity of the liquid material is adjusted. Consequently, in the case where liquid material is ejected using the droplet ejection method, ejection defects due to clogging are prevented. A high-quality liquid-crystal device is manufactured by highly precise disposition of material where droplet ejection is stably conducted.

In this embodiment, for forming the alignment film and the like by the droplet ejection method, the amount of consumed material and the amount of wasted liquid can be greatly reduced compared to the flexo method, and there is a major energy conservation effect. In addition, it is possible to easily accommodate enlargement of the substrate, and to manufacture film of high quality.

Electronic Equipment

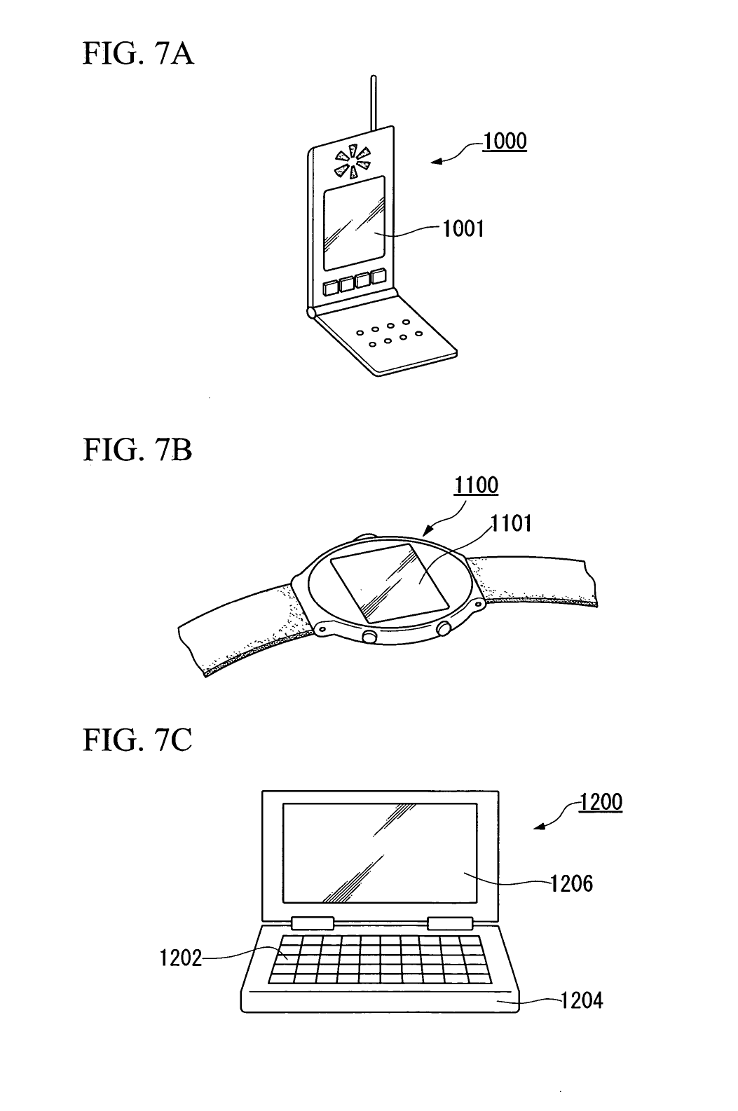

FIGS. 7A to 7C are views of embodiments of the electronic equipment of this invention.

The electronic equipment of this embodiment is provided with the aforementioned liquid-crystal device as a display device.

FIG. 7A is a perspective view of one example of a cell phone. In FIG. 7A, reference symbol 1000 indicates the cell phone body, and 1001 indicates the display device using the aforementioned liquid-crystal device.

FIG. 7B is a perspective view of one example of an electronic wristwatch. In FIG. 7B, reference symbol 1100 indicates the watch body, and 1101 indicates the display device using the aforementioned liquid-crystal device.

FIG. 7C is a perspective view of one example of a portable information processing device such as a personal computer. In FIG. 7C, reference symbol 1200 indicates the information processing device, 1202 indicates the input device such as a keyboard, 1204 indicates the body of the information processing device, and 1206 indicates the display device using the aforementioned liquid-crystal device.

As the respective pieces of electronic equipment shown in FIGS. 7A to 7C are furnished with the aforementioned liquid-crystal device as the display device, it is possible to obtain high-quality electronic equipment free of display defects.

The liquid-crystal device of the foregoing embodiment is not limited to the aforementioned electronic equipment, and may be suitably used as the image display device of electronic books, personal computers, digital still cameras, video monitors, video tape recorders of the viewfinder type or the monitor direct-view type, car navigation devices, pagers, electronic notebooks, electronic calculators, word processors, work stations, television phones, PSO terminals, and equipment provided with touch panels, and so on. Such electronic equipment will enjoy excellent reliability while being inexpensive.

While preferred embodiments of this invention have been described and illustrated above, it should be understood that these are exemplary of the invention, and are not to be considered as limiting. Additions, omissions, substitutions, and other modifications can be made without departing from the spirit or scope of this invention. Accordingly, the invention is not to be considered as being limited by the foregoing description, and is only limited by the scope of the appended claims.

What is claimed is:

1. A dilution method for liquid material used for forming an alignment film, comprising:
diluting the liquid material by adding a diluent having a prescribed solubility parameter to the liquid material; wherein the diluent is a solvent having a solubility parameter which is substantially identical to a solubility parameter of the liquid material.

2. The dilution method for liquid material used for forming an alignment film, according to claim 1, wherein when the solubility parameter of the liquid material is σi, and the solubility parameter of the diluent is σs, the ratio σs/σi is greater than or equal to 0.8 and less than 1.2.

3. The dilution method for liquid material used for forming an alignment film, according to claim 2, wherein the ratio σs/σi is greater than or equal to 0.9 and less than 1.1.

4. The dilution method for liquid material used for forming an alignment film, according to claim 1, wherein the liquid material includes a plurality of solvents, and the diluent is the solvent having a solubility parameter which is closest to a solubility parameter of the liquid material among the plurality of solvents included in the liquid material.

5. The dilution method for liquid material used for forming an alignment film, according to claim 1, wherein the diluent is a solvent which has a solubility parameter which is substantially identical to a solubility parameter of the liquid material, and which is not included in the liquid material.

6. A manufacturing method for liquid-crystal device, comprising:
disposing a liquid material on a substrate by a droplet ejection method; wherein, the liquid material is used for forming an alignment film, and the liquid material is diluted by the dilution method according to claim 1.

7. An Electronic equipment comprising:
the liquid-crystal device manufactured by the manufacturing method according to claim 6.
